(19) United States
(12) Patent Application Publication
(10) Pub. No.: US 2010/0044207 A1
(43) Pub. Date: Feb. 25, 2010

(54) Liquid refining device

(75) Inventor: Charles Andrew Lowry, Riverton, UT (US)

Correspondence Address: Innova Enterprises, Inc.;Attn: Tom Sawyer, 3449 Seven Springs Drive, Sandy, UT, 84092, US

(73) Assignee: Innova Enterprises, Inc.

(21) Appl. No.: 12/229,442

(22) Filed: Aug. 22, 2008

(51) Int. Cl. B01D 1/00; B01D 35/18

(52) U.S. Cl. 203/89; 210/808; 210/188

(57) ABSTRACT

A liquid refining device for separation and removal of volatile contaminants from liquids. A first feature of this design is the use of an Evaporation/separation chamber comprising two separate channels, one for collecting the purified liquid, and the other for collecting and passing the separated and vaporized contaminants therefrom.

### BACKGROUND OF THE INVENTION

1. Field of the Invention

The present invention relates to a device for purifying liquids, and particularly relates to such a liquid purifying device utilizing the process of distillation/evaporation of volatile contaminants contained within a liquid to separate and remove such volatile contaminants from the contaminated liquid, and more particularly relates to such a device that utilizes an evaporation/separation chamber comprising two separate channels, one for collecting the purified liquid, and the other for collecting and passing the separated and vaporized contaminants therefrom.

2. Description of the Prior Art

There presently exist a number of distillation-type liquid separation and reclamation devices for evaporation/separation and removal of volatile contaminants from contaminated liquid. Most of these units are directed to purifying vehicle engine oil, and utilize what is called the thin-film evaporation process, wherein the oil is passed over a heated flat horizontal surface (evaporation plate), the theory being that the heat will cause the oil to flow to such a “thin film” on the flat horizontal surface that volatile contaminants having a boiling point lower than that of the temperature of the evaporation plate will be evaporated, followed by a collection of the “purified” oil following contaminant evaporation. In addition, most of these thin-film evaporation-type distillation units incorporate a separate heating element (generally electric) for maintaining the evaporation plate at the desired temperature. Typical of these units are shown in U.S. Pat. Nos. 1,718,800, 2,472,717, and 4,006,084.

Similar evaporation units incorporate vertical fins into the heated evaporation plate in order to provide more heated surface area for the oil and to cause the oil to reach its “thin-film state” more readily as it flows down the vertical sides of the fins, the theory being to increase the speed and efficiency of evaporation of the volatile contaminants from the oil. Oil evaporation/separation units of this type are shown in U.S. Pat. Nos. 2,839,196, 3,756,412, 4,115,201, 4,189,351, 4,146,475, 4,289,583, 4,443,334, 4,349,438, 4,354,946, 4,369,110, 4,717,474, 4,943,352, 4,830,745, 5,242,034, 5,322,596, 5,630,956, and 5,630,912.

One of the problems with these prior art thin-film evaporation units is that an electric heating element in the general vicinity of volatile contaminants and engine fuel creates a potentially explosive environment. Another problem with prior art thin-film evaporation units is that the evaporation plates must be maintained almost perfectly horizontal in order to be efficient. Another problem with such units is that they are complicated and expensive to manufacture and service. Another problem is that such prior art units are prone to clogging, thus disabling the unit. Also, such prior art units have no means to determine if and when the unit is clogged and therefore not functioning.

Applicant's own U.S. Pat. Nos. 5,824,211 and 5,776,315 disclose evaporative distillation units that do not require separate heating elements in order to maintain the temperature of the liquid at the contaminant vaporization temperature. Rather, vaporization heat is provided by the liquid itself.

### OBJECTS OF THE INVENTION

It is therefore an object of the present invention to provide a device for removing volatile contaminants from liquid that utilizes heat from the liquid to effect vaporization of the contaminants, rather than a separate heating element.

It is further object of the present invention to provide such a device that incorporates separate liquid and vapor removal channels.

It is a further object of the present invention to provide such a device that is small and compact, and is simple and time-efficient in servicing and maintenance.

It is a still further object of the present invention to provide such a device that does not have to be perfectly level in order to function properly.

It is still further object of the present invention to provide such a device that is practically immune to clogging.

It is still further object of the present invention to provide such a device that facilitates quick and simple determination if and when it ever does clog and cease functioning.

### SUMMARY OF THE INVENTION

The liquid purifying device (10) of the present invention is utilized for separating and removing volatile contaminants from fluids. In one embodiment, the device incorporates a self-contained particle filter (16) for filtering particles from the contaminated liquid. The liquid purifying device (10) itself comprises an evaporation/distillation chamber positioned essentially inside the annular interior void of the particle filter media, and receives contaminated liquid that has been filtered by the filter media (20). The filtered contaminated liquid is passed through the evaporation/distillation chamber, which comprises an evaporation/distillation conduit (24) and an evaporation plug (32) positioned within the conduit to effect metering of the liquid into the evaporation/distillation conduit. The conduit (24) also includes an evaporation mechanism (28) positioned thereinside. The evaporation mechanism (28) comprises a plate (34) for thin-film evaporation of the volatile contaminants from the liquid, the plate having agitation devices (44) for cascading the liquid down the evaporation plate, creating a churning, tumbling, and kneading of the liquid to thereby enhance and facilitate more efficient vaporization and release of volatile contaminants from the liquid. The evaporation/distillation chamber defines two separate but communicating channels therein: a vapor channel (38) and a processed liquid channel (40). Heat for evaporation/distillation of the volatile contaminants from the liquid acting directly on the evaporation plate (34) is provided by the heated liquid itself, without the necessity of a separate heating element to maintain the vaporization temperature of the evaporation plate. In some applications, the heated contaminated liquid surrounds the evaporation/distillation conduit (24) and chamber in order to maintain the conduit at the necessary temperature for contaminant evaporation. In other applications, the heat from the contaminated liquid is sufficient to maintain the temperature of the evaporation plate high enough to effect contaminant evaporation.

The liquid purifying device is typically used in a by-pass filter capacity with an internal combustion engine, whereby a small amount of contaminated engine oil is tapped from the oil pump and processed through the liquid purifying device, whereupon the volatile contaminants are vaporized, separated, and removed from the oil. The processed lubricating oil is then returned to the engine oil pan.

In other applications, the particle filter may or may not be used. Rather, contaminated liquid-hydraulic fluid, drilling mud, machining oil, cooking oil, heating/cooling fluid, etc.—with or without pre-heating—may be pumped directly into the evaporation/distillation chamber for evaporation, separation, and removal of volatile contaminants therefrom, the processed fluid then being returned to the mechanism in which it is used.

### BRIEF DESCRIPTION OF THE DRAWINGS

FIG. 1 is a vertical sectional view of the liquid purifying device of the present invention, including the particulate filter and filter mount.

FIG. 2 is a perspective view of the first embodiment of the evaporation insert used in the liquid purifying device of the present invention.

FIG. 3 is a plan view of the first embodiment of the evaporation insert of the liquid defining device, taken in the direction of arrows 3-3 in FIG. 1.

FIG. 4 is a bottom view of the evaporation insert of FIGS. 2 and 3.

FIG. 5 is a horizontal sectional view through the evaporation insert plug within the evaporation conduit that defines the metering function, as shown by arrows 5-5 in FIG. 1.

FIG. 6 is a horizontal sectional view through the evaporation insert central post, as shown by arrows 6-6 in FIG. 1.

FIG. 7 is a horizontal sectional view through the evaporation insert positioned inside the separation conduit, illustrating the separate liquid and vapor channels therein, as shown by arrows 7-7 in FIG. 1.

FIG. 8 is a plan view of the evaporation insert similar to FIG. 3, illustrating the flow of liquid down the insert.

FIG. 9 is a plan view of a second embodiment of the evaporation insert.

FIG. 10 is a plan view of a third embodiment of the evaporation insert.

FIG. 11 is a plan view of a fourth embodiment of the evaporation insert.

FIG. 12 is a plan view of a fifth embodiment of the evaporation insert.

FIG. 13 is a bottom end view of the fifth embodiment of the evaporation insert.

FIG. 14 is a plan view of a sixth embodiment of the evaporation insert.

FIG. 15 is a partial vertical sectional view of the sixth embodiment of the evaporation insert.

### DESCRIPTION OF THE PREFERRED EMBODIMENTS

The liquid purifying device of the present invention has application in many environments. For example, the device may be used in a by-pass filter arrangement for internal combustion engines in both mobile and stationary applications. It is also contemplated that the present liquid purifying device will have application in hydraulic systems, and in industrial applications wherever hydraulic fluid (oil), cutting (machining) oil, drilling fluid, cooking oil, cleaning fluids, cooling/heating fluids, etc. are used. For purposes of description and explanation of the concept of the liquid purifying device, however, and without limiting the concept or application of the invention, the liquid purifying device will be described in an application of an oil-lubricated internal combustion engine.

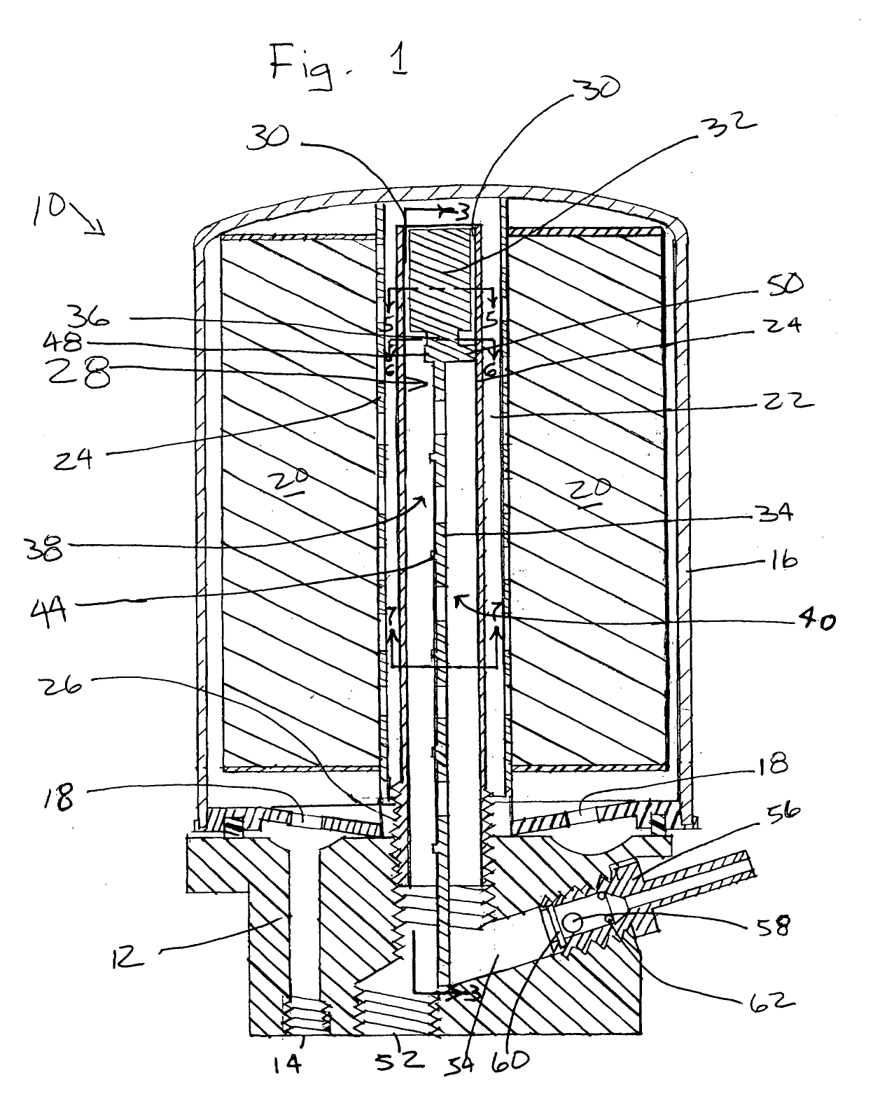

Turning now to the drawings, and initially to FIG. 1, the liquid purifying device is shown generally illustrated by the numeral 10. The general concept of the liquid purifying device of the present invention is similar to that of prior art devices. The device includes a combination mounting bracket and filter mount (12) for mounting on the side of an engine block, firewall, vehicle frame, etc. The filter mount (12) includes a contaminated oil inlet (14) for receiving oil under pressure from the engine oil pump (not shown). The contaminated oil inlet (14) communicates with a spin-on-type particulate oil filter (16) through a plurality of passageways (18) formed in the bottom of the spin-on oil filter (16).

The oil passes through the filter media (20) and into the annular filtered oil collector (22) in the customary manner. The liquid purifying device of the present invention, however, has incorporated an evaporation chamber for volatile contaminants inside this annular filtered oil collector (22). The evaporation chamber is located inside the spin-on filter for a number of reasons: (1) simplicity; (2) efficient use of space; (3) to maintain the oil at the proper temperature for contaminant evaporation; (4) minimization of oil piping and connections. In a preferred embodiment of the present invention, a three micron particulate filter is used for the filter media (20) in order to optimize the filtration and minimize the possibility of clogging of the oil metering device, which will be explained hereinbelow.

The specific apparatus for separating and removing volatile vapor contaminants from the oil is formed within a separation conduit (24) that is permanently attached to, and becomes part of, the filter mount (12). In a preferred embodiment, the separation conduit takes the form of a steel cylinder that is threaded at (26) on one end (the bottom end as shown in FIG. 1) and is threadedly mounted to the filter mount (12) as shown. As can be appreciated, conventional filter mounts for spin-on type oil filters generally include an externally threaded nipples for receiving the internally threaded base of the spin-on filter. This design of the separation conduit (24) is similar to the threaded nipple, except that the conduit extends to almost the entire interior length of the particulate oil filter, but is not threaded the entire length, to define the separation conduit (24).

The present invention incorporates an evaporation insert (28) that is positioned within the separation conduit (24), as shown in FIG. 1, and extends literally into the filter mount (12) to the tapered end of the borehole which threadedly receives the separation conduit (24). With the evaporation insert (28) inserted in the separation conduit (24), an annular metering orifice (30) is defined in the annular space between a plug portion (32) of the evaporation insert and the top interior diameter of the separation conduit (24).

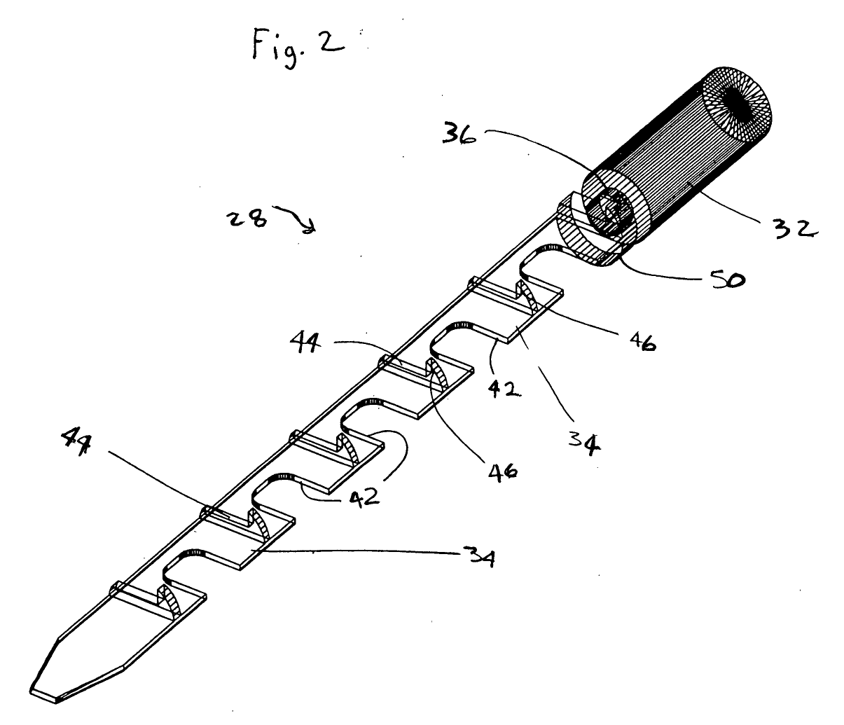

FIG. 2 is a perspective view of the first embodiment of the evaporation insert of the present invention. As shown, it comprises the plug (32) connected to a generally elongate plate (34) by a central post (36).

Referring again to FIG. 1, it can be seen that the evaporation insert plate (34) essentially divides the separation conduit (24) longitudinally into two essentially separate channels. These two channels will be further explained hereinbelow as the liquid channel (38) on the left and the vapor channel (40) on the right, as shown in FIG. 1.

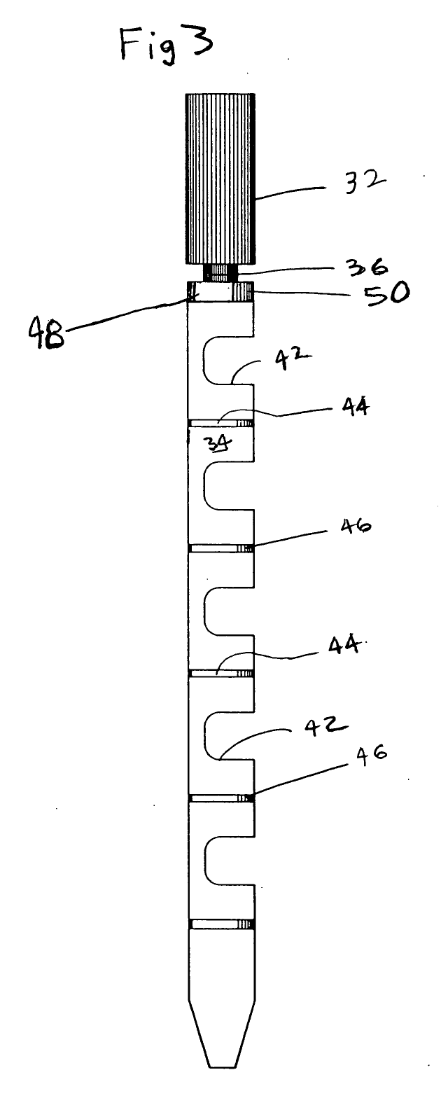

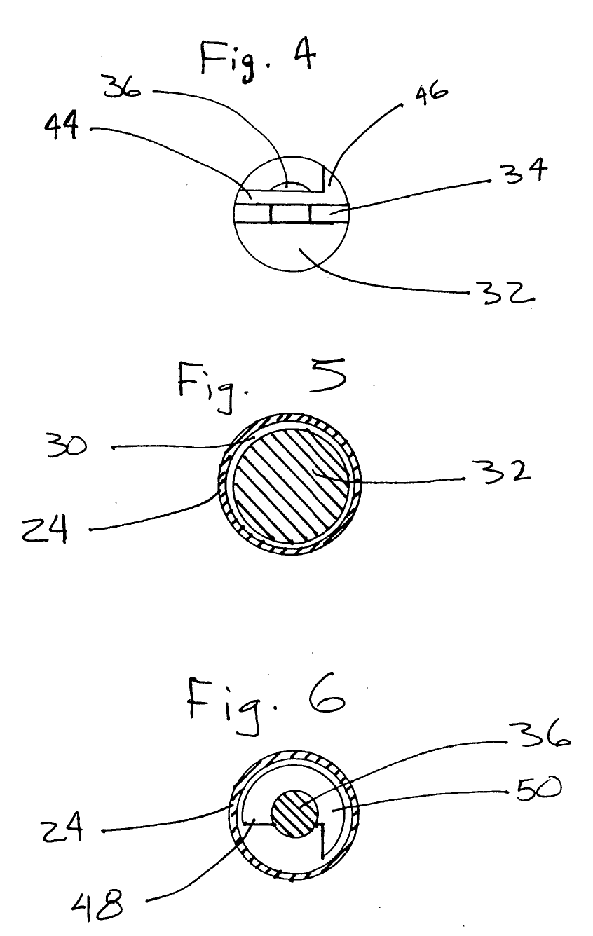

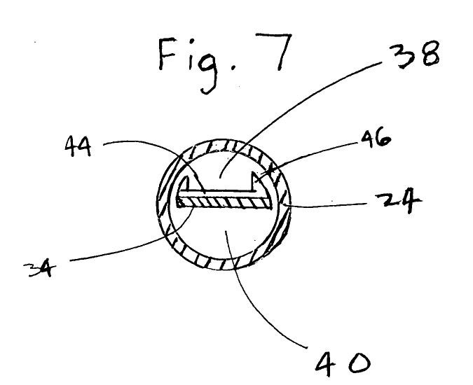

As best shown in FIGS. 2 and 3, the evaporation insert plate includes a plurality of cutouts or apertures (42) that provide communication between the liquid channel (38) and vapor channel (40) on opposite sides of the plate within the separation conduit (24). FIGS. 2 and 3 also illustrate that the evaporation insert plate is formed with a plurality of essentially horizontal (as oriented in FIGS. 1 and 3) ridges (44) extending across the diameter of the plate. Also best shown in FIG. 2, these evaporation plate ridges (44) include barbs (46), the function of which will be described in greater detail hereinbelow.

The top evaporation insert plate ridge (48) which directly connects to the evaporator insert central post (36) also includes a semi-circular boss (50) (best shown in FIG. 2) that serves as a liquid barrier or seal between the metering orifice (30) and the vapor channel (40) within the separation conduit. The diameter of this semi-circular boss (50) approximates that of the evaporation insert plug (32). Diametrically opposite the semi-circular boss (50) is a void adjacent the top evaporation insert plate ridge (48), for directing the oil from the annular metering orifice (30), through the void, and onto the evaporation insert plate (34), in a manner to prevent the oil from draining down into the vapor channel (40) during processing.

Returning to FIG. 1, it can be seen that the liquid channel (38) within the separation conduit (24) is in communication with a processed liquid outlet (52), and the evaporation channel (40) is in communication with a vapor outlet (54). As can be appreciated, the processed liquid outlet (52) communicates with the engine oil pan or fluid reservoir for return of the processed oil back to the engine oil pan, or return of the processed fluid (whatever it may be) back to the reservoir. It should be pointed out that, regardless of the orientation of the evaporation insert (28), and therefore the orientation of the liquid channel (38) and vapor channel (40) within the separation conduit (24), due to the open design and orientations of the processed liquid outlet (52) and vapor outlet (54), processed oil and vaporized contaminants automatically proceed to their appropriate outlets for discharge.

Turning again to FIG. 1, and specifically the vapor outlet (54), it can be seen that a nipple (56) is screwed into the vapor outlet for connection to a vapor exhaust hose. It should also be noted that the vapor outlet (54) is angled upwardly in order to prevent the escape of any processed oil out the vapor outlet. In addition, the nipple (56) includes what essentially amounts to a “vapor valve” in the form of a sealing ball (58) position within the nipple and retained therein by either an O-ring or snap ring (60). The sealing ball (58) is preferably made of acetyl nitrate. This “vapor valve” permits vaporized gasses to escape around the ball and through the vapor outlet and nipple (56), but, due to the specific gravity of the sealing ball, prevents oil from passing through the vapor nipple by the sealing ball floating on any oil that may back up into the nipple, and sealing against a “sealing” second O-ring (62).

### Operation

In operation, contaminated oil to be purified enters the filter mount (12) at the oil inlet (14). This contaminated oil is under pressure, and can come from the oil pump or from the conventional oil filter outlet (not shown) by tapping an oil line from either upstream or downstream of the conventional filter, respectively. The contaminated oil to be processed passes through the particulate oil filter oil passageways (18), and up the annular passageway that surrounds the filter media (20), in a customary manner. Oil that is filtered through the media (20) then begins to collect in the bottom of the annular space within the filter oil collector (22) between the filter media and the separation conduit (24). When the level of oil in this annular space around the separation conduit (24) reaches the top of the conduit, pressure then begins to force the oil down through the annular metering orifice (30) between the evaporation insert plug (32) and separation conduit (24), whereupon the pressure drops considerably (to ambient or atmospheric pressure), due of course, to the metering orifice. The sudden drop of pressure facilitates evaporation of volatile contaminants that have been emulsified in the oil during its lubrication function. In non-internal combustion engine or other industrial applications, the fluid to be purified can preferably be filtered first, or can go directly to the separation conduit and evaporation insert. In these applications, this drop in pressure in industrial designs that do not utilize a metering device can be effected by a vacuum pump.

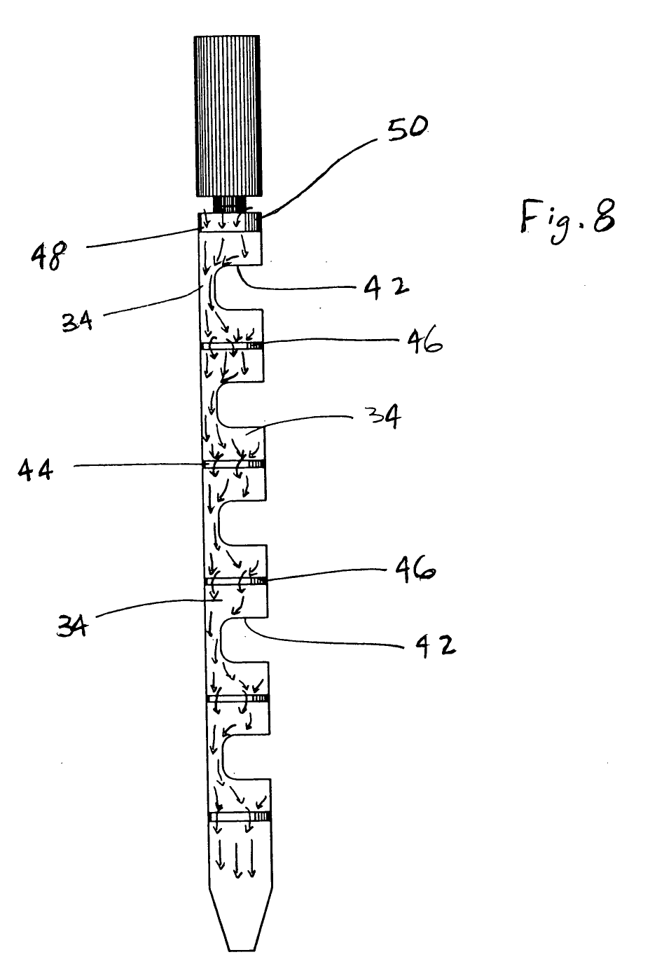

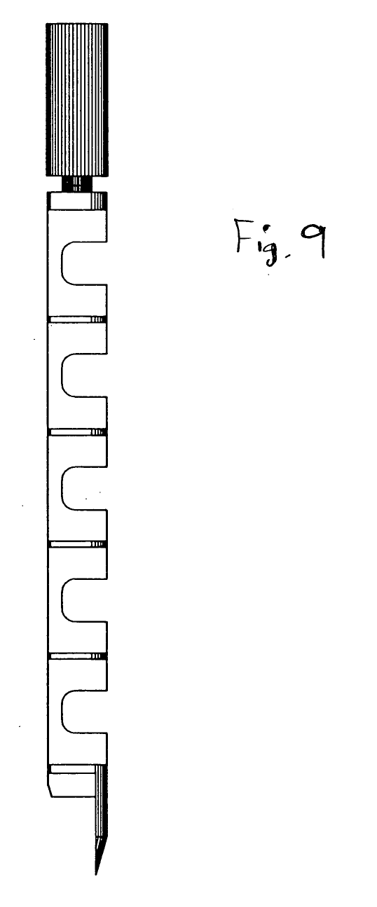

FIG. 8 is similar to FIG. 3 and is taken in the direction of arrows 3-3 in FIG. 1. FIG. 8 illustrates the path that this oil takes as it is processed through the liquid purifying device down the evaporation insert plate, and specifically, the steps occurring during oil processing/purifying and vaporization of the volatile contaminants from the contaminated oil. Contaminated oil exiting the metering orifice (30) collects on the top semi-circular ridge boss (50) and is directed toward the front (illustrated) side of the separation conduit, the liquid channel (38). The oil then builds up around the top semi-circular ridge boss (50) and cascades over the top of the boss, through the void in the top evaporation plate ridge (48), and onto the top vertical section of the evaporation insert plate on the front (illustrated) side of the separation conduit (i.e., within the liquid channel 38). At this juncture, the oil maintains sufficient heat to heat the separation conduit and the evaporation insert plate. As the oil cascades over the top evaporation insert plate ridge (48) at the location of the void and flows down the top section of evaporation insert plate (34), the agitation caused by cascading over the top evaporation plate ridge (48) more efficiently causes the volatile contaminants within the contaminated oil to vaporize and be released from the oil. Also, as the oil flows down the various sections of evaporation insert plate (34), it flows in a heat-induced thin-film, which effects the thin-film evaporation of the volatile contaminants from the oil.

As can be appreciated from an understanding of the mechanical details of the evaporation insert as shown in FIGS. 2, 3, and 8, as the oil flows down the liquid channel side of the insert of the vaporization insert plate, it encounters an aperture (42) which provides communication between the liquid channel and the vapor channel. Oil surface tension causes oil flowing on the evaporation insert plate (34) to circumvent this aperture in the counterclockwise direction as shown in FIG. 8, and be added to the flow of oil down the left side of the evaporation insert plate, as shown in FIG. 8. This oil is mixed and then permitted to flow around the evaporation plate aperture (42), and down to the subsequent evaporation plate ridge (44), where the oil again collects on top of the ridge. When a sufficient amount of oil has collected on top of the ridge, it cascades over the ridge and onto the lower section of the evaporation insert plate. As the oil cascades over the series of evaporation plate ridges (44), the oil is kneaded, tumbled, and churned, thereby more efficiently releasing vaporized contamination from the oil. In this regard, the evaporation plate ridge barbs (46) form a physical barrier against oil flowing over the ridge at the extreme right edge thereof, as shown in FIG. 8, in order to prevent a build-up of oil along the right (outside) edge of the plate which would otherwise tend to accumulate there and possibly drip to the plate or ridge below. Therefore, the evaporation plate's ridge barbs (46) function to direct the flow of oil away from the edges of the apertures (42) and toward the greater surface area of the evaporation insert plate for more efficient thin-film evaporation of the vaporized contaminants therefrom.

Those skilled in the art will appreciate that the separation conduit and evaporation insert need not be perfectly vertical while oil is being processed therethrough. This is because oil surface tension routes the oil around the respective evaporation insert plate apertures in a thin-film on each section of evaporation insert plate. Therefore, the oil has no chance to accumulate into a thick-film on the plate sections, but rather, maintains its thin-film form until it accumulates slightly on each successive evaporation insert plate ridge, whereupon the oil is again churned, tumbled, and kneaded as it cascades over the plate ridges, thereby causing increased efficiency in evaporation of the volatile contaminants from the oil. It can also be appreciated that, once the initial flow of oil reaches the bottom of the evaporation insert, it will drop into the bottom of the filter mount cavity and flow out the processed liquid outlet (52). Once flowing, this oil flow will remain continuous and uninterrupted down each sequential section of the evaporation insert plate for continuous oil purifying.

As can be appreciated, as these various volatile contaminants vaporize and are separated from the initially contaminated oil, the accumulation of vapor requires a means of exhaust. Because of the fact that the liquid channel within the separation conduit forms essentially part of a closed system, the pressure within the closed system, and therefore within the liquid channel (38) remains essentially constant. Therefore, as the various contaminants vaporize and expand, the vapor is forced through the various evaporation plate apertures (42) and into the vapor channel (40) where it tends to collect. Because of the fact that the separation conduit (24) is constantly heated by the inflow of contaminated oil from the filter media (20), this vapor is not permitted to condense on the inside wall of the separation conduit, but rather, remains in a vapor state, and is therefore forced out the bottom of the vapor channel (40) and out the vapor outlet (54), as progressively more volatile contaminants are vaporized within the separation conduit and caused to enter the vapor channel. In addition, in certain mobile and industrial applications, a negative pressure (a separate vacuum) can be used to withdraw the released vaporized contaminants from the evaporation chamber.

### Second Embodiment

FIG. 9 illustrates a second embodiment of the evaporation insert. The second embodiment of FIG. 9 illustrates a major portion of the bottom part of the evaporation insert having been removed in order to permit purified liquid to flow freely into the liquid channel at the bottom of the evaporation insert, in order to minimize the possibility of liquid backing up into the vapor outlet (52) and thereby sealing the vapor outlet.

### Third Embodiment

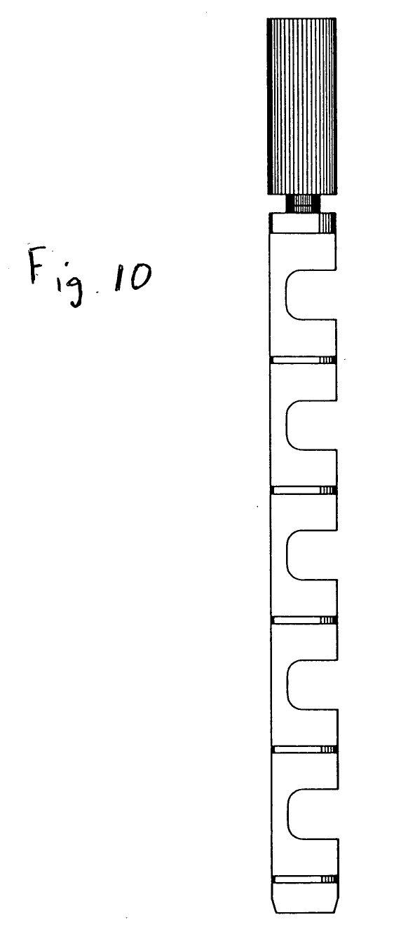

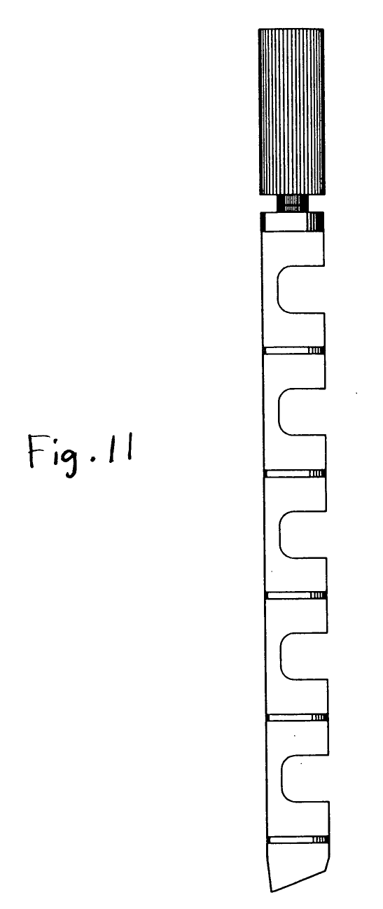

FIG. 10 illustrates a third embodiment of the evaporation insert. The third embodiment is essentially identical to the first and second embodiments, the difference being the third embodiment has a much shorter bottom evaporation insert plate section (34). The purpose of this shorter bottom plate section is identical to that of the removed portion in the second embodiment, specifically to open up the bottom interior cavity of the filter mount in order to permit purified liquid to flow freely into the liquid channel and out the filter mount processed liquid outlet.

### Fourth Embodiment

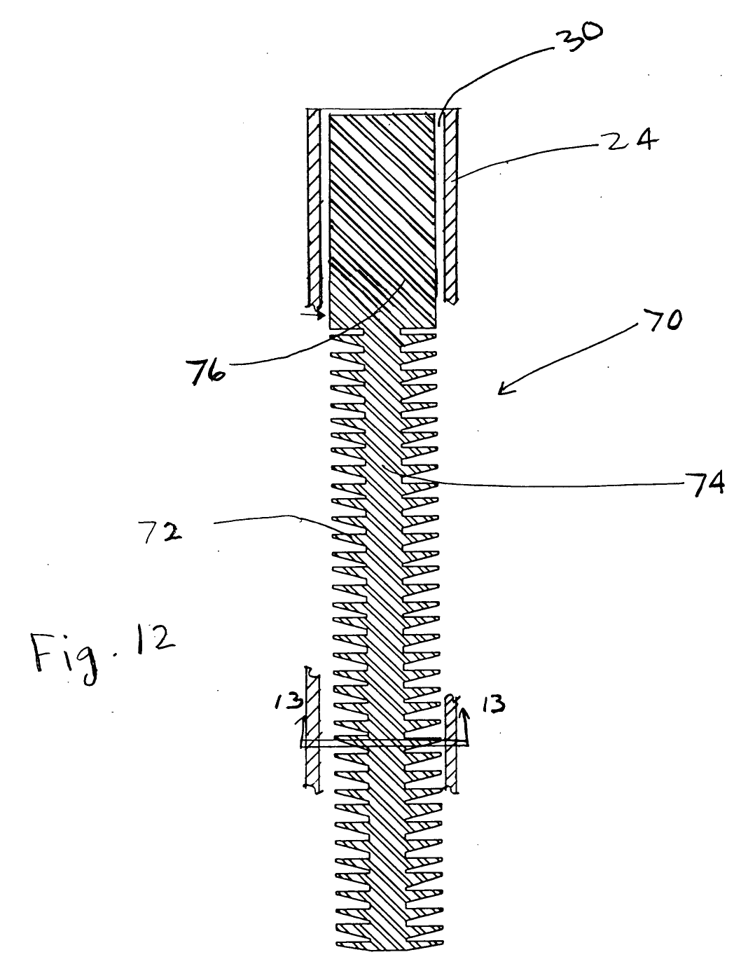

FIG. 11 illustrates a fourth embodiment of the evaporation insert. The fourth embodiment is essentially identical to the third embodiment, the difference being that the bottom section of the evaporation insert plate (34) is cut at an angle rather than straight across. The purpose of this embodiment is identical to that of the third embodiment, with the added benefit that processed fluid is caused to accumulate at the low point (tip) of the evaporation insert plate, facilitating its collection in the bottom of the filter mount.

### Fifth Embodiment

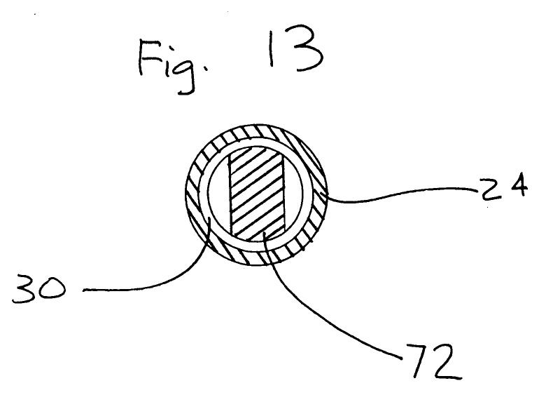

FIG. 12 illustrates a fifth embodiment of the evaporation insert used in the liquid purifying device of the present invention, this fifth embodiment of the evaporation insert being indicated at (70). This fifth embodiment incorporates a plurality of essentially flat and level disks or fins (72) concentrically fixed about a central support (74). The central support (74) is attached to the evaporation insert plug (76) and forms a part thereof. Metering is effected in this fifth embodiment in the same manner as in the previous embodiments with the evaporation insert fitted into the separation conduit (24).

FIG. 13 illustrates the liquid channel and vapor channel defined by this fifth embodiment of the evaporation insert (70) as being a series of voids formed in the fins (72) diametrically each other on opposite sides of the central support. The separate liquid channel and vapor channel therefore isolate and separate the various vaporized volatile contaminants from the oil as it cascades down and around each of the fins onto the subsequent lower fin in a manner similar to that in which these volatile contaminants are vaporized from the contaminated oil by the action of the oil cascading down the series of evaporation plate ridges and plate sections of the previous embodiments of the evaporation insert. At the bottom of the evaporation insert, the vapor is drawn off and the purified oil is permitted to flow separately from the separation conduit, as in the procedure described with reference to FIG. 1.

### Sixth Embodiment

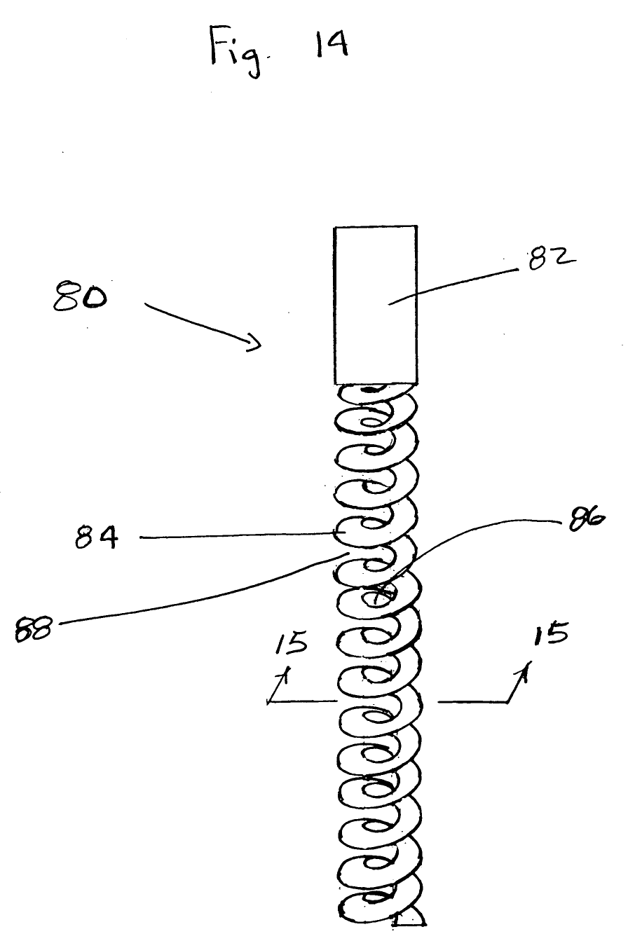

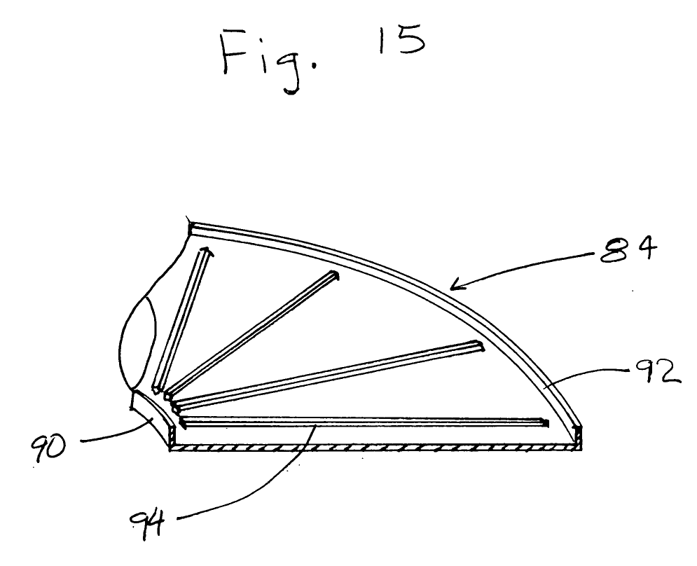

FIG. 14 illustrates a sixth embodiment (80) of the evaporation insert for use with the liquid purifying device of the present invention. This sixth embodiment includes the evaporation insert plug (82) as in the previous embodiments, but directs the contaminated oil for distillation/evaporation in a slightly different path. The sixth embodiment (80) of the evaporation insert takes the form of a spiral ribbon (84) having an outside diameter essentially identical to or slightly less then the inside diameter of the evaporation conduit. This spiral ribbon (84) also defines the vapor channel (86) in the geometric center thereof, while forming the liquid channel (88) in the space directly above the spiral ribbon.

FIG. 15 is a sectional view of the spiral ribbon (84), and illustrates inner and outer barriers (90), (92) that define a channel for directing the liquid flow spirally down the top surface of the ribbon. FIG. 15 also illustrates the inclusion of a number of horizontal ridges (94) that serve as impediments to the flow of liquid down the ribbon, and cause the liquid flow to be kneaded, tumbled, and churned as it cascades over these ridges in a manner similar to that described with reference to the operation of the previous embodiments of the evaporation insert.

The operation of the fifth and sixth embodiments of the evaporation insert in conjunction with the liquid purifying device of the present invention is essentially the same as previously described with regard to the previous embodiments, and therefore will not be repeated.

From the foregoing it will be seen that this invention is one well adapted to attain all of the ends and objectives herein set forth, together with other advantages which are obvious and which are inherent to the design and method. It will be understood that certain features and subcombinations are of utility and may be employed with reference to other features and subcombinations. This is contemplated by and is within the scope of the claims. For example, the device may be used in a by-pass filter arrangement for internal combustion engines in both mobile and stationary applications. It is also contemplated that the present liquid purifying device will have application in hydraulic systems, and in industrial applications wherever hydraulic fluid (oil), cutting (machining) oil, drilling fluid, cooking oil, cleaning fluids, cooling/heating fluids, etc. are used. Many possible embodiments may be made of the invention without departing from the scope of the claims. It is to be understood that all matter herein set forth or shown in the accompanying drawings is to be interpreted as illustrative and not in a limiting sense.

### LIST OF REFERENCE NUMERALS

10 liquid purifying device
12 filter mount
14 contaminated oil inlet
16 particulate oil filter
18 particulate oil filter oil passageways
20 filter media
22 annular filter oil collector
24 separation conduit
26 separation conduit threads
28 evaporation insert
30 metering orifice
32 evaporation insert plug
34 evaporation insert plate
36 evaporation insert central post
38 liquid channel
40 vapor channel
42 evaporation insert plate apertures
44 evaporation insert plate ridges
46 barbs
48 top evaporation insert plate ridge
50 semi-circular ridge boss
52 processed liquid outlet
54 vapor outlet
56 nipple
58 sealing ball
60 O-ring or snap ring
62 second O-ring
70 fifth embodiment evaporation insert
72 evaporation insert fins
74 evaporation insert central support
76 evaporation insert plug
80 sixth embodiment evaporation insert
82 evaporation insert plug
84 evaporation insert spiral ribbon
86 vapor channel
88 liquid channel
90 inner barrier
92 outer barrier
94 horizontal ridges

What is claimed is:

1. Apparatus for separating and removing volatile contaminants from a liquid, comprising:
a separation conduit for passing the liquid containing volatile contaminants therethrough; and
an evaporation insert positioned within the separation conduit, the evaporation insert comprising:
liquid flow means defining a liquid channel within the separation conduit for directing a flow of liquid to and through the liquid channel;
vapor flow means defining a vapor channel within the separation conduit for directing a flow of vapor to and through the vapor channel; and
liquid agitation means formed in the liquid channel for agitating the liquid as it flows through the liquid channel, thereby causing release of the volatile contaminants in the form of vapors from the liquid.

2. Apparatus as set forth in claim 1, further comprising metering means for metering liquid flow through the separation conduit upstream of the evaporation insert.

3. Apparatus as set forth in claim 1, wherein the evaporation insert comprises a plate oriented longitudinally, and essentially diametrically within the separation conduit, defining the liquid channel on one side thereof and the vapor channel on the opposite side thereof.

4. Apparatus as set forth in claim 1, wherein the evaporation plate includes at least one aperture therein for establishing communication between the liquid channel and the vapor channel.

5. Apparatus as set forth in claim 1, wherein the liquid agitation means comprises a transverse ridge formed on the plate within the liquid channel, extending from the plate sufficiently to agitate the flow of liquid as liquid flows over the ridge.

6. Apparatus as set forth in claim 4, further comprising a plurality of apertures.

7. Apparatus as set forth in claim 6, further comprising a plurality of agitation ridges coordinated with respective apertures.

8. Apparatus as set forth in claim 7, wherein the plurality of apertures and ridges are formed in alternating orientation along the length of the plate.

9. Apparatus as set forth in claim 1, further comprising a vapor exhaust conduit in communication with the separation conduit.

10. Apparatus as set forth in claim 1, further comprising a processed liquid exhaust conduct in communication with the separation conduit.

11. Apparatus as set forth in claim 9, wherein the vapor exhaust conduit communicates with the separation conduit adjacent the vapor channel.

12. Apparatus as set forth in claim 10, wherein the processed liquid exhaust conduit is in communication with the separation conduit adjacent the liquid channel.

13. Apparatus as set forth in claim 2, wherein the separation conduit is cylindrical and the metering means comprises a plug positioned within the separation conduit having an outside diameter slightly less than the inside diameter of the cylindrical separation conduit.

14. Apparatus as set forth in claim 2, wherein the metering means is formed with the evaporation insert.

15. Liquid reclamation device for removing solid and volatile liquid impurities and contaminants from liquids, comprising:
a mounting base for receiving a liquid particulate filter, the mounting base having a liquid inlet for receiving liquid to be filtered, a liquid outlet for passing filtered liquid, and a vapor outlet for passing vaporized impurities and contaminants;
a separation conduit for passing the liquid containing volatile contaminants therethrough; and
an evaporation insert positioned within the separation conduit, the evaporation insert comprising:
liquid flow means defining a liquid channel within the separation conduit for directing a flow of liquid to and through the liquid channel;
vapor flow means defining a vapor channel within the separation conduit for directing a flow of vapor to and through the vapor channel; and
liquid agitation means formed in the liquid channel for agitating the liquid as it flows through the liquid channel, thereby causing release of the volatile contaminants in the form of vapors from the liquid.

16. Liquid reclamation device as set forth in claim 15, further comprising metering means for metering liquid flow through the separation conduit upstream of the evaporation insert.

17. Liquid reclamation device as set forth in claim 16, wherein the evaporation insert comprises a plate oriented longitudinally, and essentially diametrically within the separation conduit, defining the liquid channel on one side thereof and the vapor channel on the opposite side thereof.

18. Liquid reclamation device as set forth in claim 15, wherein the evaporation plate includes at least one aperture therein for establishing communication between the liquid channel and the vapor channel.

19. Liquid reclamation device as set forth in claim 15, wherein the liquid agitation means comprises a transverse ridge formed on the plate within the liquid channel, extending from the plate sufficiently to agitate the flow of liquid as liquid flows over the ridge.

20. Liquid reclamation device as set forth in claim 17, further comprising a plurality of apertures.

21. Liquid reclamation device as set forth in claim 20, further comprising a plurality of agitation ridges coordinated with respective apertures.

22. Liquid reclamation device as set forth in claim 21, wherein the plurality of apertures and ridges are formed in alternating orientation along the length of the plate.

23. Liquid reclamation device as set forth in claim 15, further comprising a vapor exhaust conduit in communication with the separation conduit.

24. Liquid reclamation device as set forth in claim 15, further comprising a processed liquid exhaust conduct in communication with the separation conduct.

25. Liquid reclamation device as set forth in claim 22, wherein the vapor exhaust conduit communicates with the separation conduit adjacent the vapor channel.

26. Liquid reclamation device as set forth in claim 23, wherein the processed liquid exhaust conduit is in communication with the separation conduit adjacent the liquid channel.

27. Liquid reclamation device as set forth in claim 16, wherein the separation conduit is cylindrical and the metering means comprises a plug positioned within the separation conduit having an outside diameter slightly less than the inside diameter of the cylindrical separation conduit.

28. Liquid reclamation device as set forth in claim 16, wherein the metering means is formed with the evaporation insert.

29. A method for separating and removing volatile contaminants from a liquid, the method comprising the following steps:
passing a heated contaminated liquid in contact with an evaporation device defining a liquid flow channel and a vapor flow channel;
maintaining pressure around the evaporation device at a level that will cause evaporation of contaminants within the liquid;
collecting the evaporated contaminants in the vapor flow channel; and
collecting the remaining liquid in the liquid flow channel.
